(19) United States
(12) Patent Application Publication
(10) Pub. No.: US 2009/0236869 A1
(43) Pub. Date: Sep. 24, 2009

(54) Light attenuator for automobile drivers

(76) Inventor: Joseph E. Newgarden, JR., Hendersonville, TN (US)

Correspondence Address: Garry William Owens, 1851 Horn Springs Road, Lebanon, TN, 37087, US

(21) Appl. No.: 12/077,927

(22) Filed: Mar. 24, 2008

(51) Int. Cl. B60J 3/02

(52) U.S. Cl. 296/97.4

(57) ABSTRACT

An automobile light attenuating system mounted above the doors and windshield around both sides and the front of an automobile interior designed to allow a special light-blocking plate to be positioned along a support frame by an automobile driver using simple finger-tip controls mounted on a steering wheel. A carriage supports and conveys the light-blocking plate throughout the range of the support frame when a dc motor is activated. The DC motor draws the carriage along the frame by pulling a cable in a first or a second, opposite, direction, according to the position of control switches activated by the automobile driver. Thus, a driver is able to conveniently and quickly move an effective light attenuating means into any optimal position between himself or herself and a source of bright light to reduce the blinding effect caused by the bright light.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the invention

The present invention generally relates to accessory devices for automobile interiors, and more particularly, to those devices currently known as sun visors. It has long been obvious to any driver of automobiles, as well as the manufacturers of said automobiles, that providing some means of preventing the driver from being blinded by the sun or other bright lights at certain angles and under certain circumstances is a necessary auxiliary function in said automobiles. For that reason, said automobile manufacturers have created adjunct accessory devices specifically for the said purpose of blocking the light from a driver's eyes. The fact is, however, that these blocking devices, called sun visors, which have been installed in automobiles for many years, have not been truly effective in accomplishing this stated purpose, and have changed very little in design or shape since their inception. The basic design of said sun visors is a strip of opaque material that can be rotated into the driver's field of vision, thereby more or less completely blocking the vision of said driver, depending upon the angle at which said visor is deployed relative to the line of sight of said driver's eyes.

Therefore, it is clearly obvious that there is a strong need for a more effective device to accomplish the aforesaid purpose of preventing bright lights from blinding said driver of said automobile. In recent years, several systems and devices have been created to address this need, but, as yet, with little or no success. The device of the present invention is believed by the inventor to finally achieve this desired effect satisfactorily by utilizing recent advances made in modern technology. 2. Description of the Related Art

The following are Patents that have previously been granted for devices relating to the subject with which the present invention is concerned. Each of these disclosures is believed by the inventor of the present invention to differ markedly from his invention.

In U.S. Pat. No. 4,919468, titled “Dual Sun Visors,” Abu-Shumays, et al, discloses a method for a pair of sun visors for covering parts of both a front windshield and a front side window of an automobile, in which said pair of sun visors may be rotated into place by automated means. It is noted, however, that said pair of sun visors are fixedly attached to the same portion of the automobile's interior and deployed in much the same way as all previous said sun visors.

Again, in U.S. Pat. No. 4,971,381, entitled, “Hinge mounted sun visors for automobiles,” Ibrahim and Mary Abu-Shumays, disclose “ . . . sun visors for independently and possibly simultaneously covering parts of the top of one or both of the front windshield and a front side window of an automobile . . . ” and, as stated in their Claim 1, “ . . . said sun visor is mounted securely to a top interior part of an automobile by a single hinge; said visor is rotatable around an axis of said hinge between a top stored position and a lowered used position, . . . ” being the same as previous said sun visors.

In U.S. Pat. No. 4,987,315, entitled Hinge mounted and slidable sun visors,” Ibrahim and Mary Abu-Shumays disclose “ . . . sun visors . . . ” “ . . . mounted to a top part of an automobile by a single hinge and can rotate between a top stored position and a lowered used position. Each visor has a visor plate along one of its sides mounted to a plate of the hinge in such a way as to make it easy to slide the visor in a horizontal direction . . . ” Although the disclosure of sliding in a horizontal direction differs from previous art, the mounting, position, and type of device remain unchanged.

U.S. Pat. No. 5,044,687 is a further disclosure of Shumays, et al, in which is claimed, “A sun visor for use to cover a corner and top part of a window of an automobile; . . . ” Although there are other functions claimed, the position, location, and mounting are seen as being the same as previous art.

In U.S. Pat. No. 4,888,072, titled Accessory support device for vehicle windshield and method of installing, Hans Ohlenforst, et al, disclose “a shaped panel . . . ” “ . . . which serves as a support and/or casing for various functional elements such as sun visors, . . . attached to windshield . . . of the vehicle.” Clearly, this device has no impingement onto the device of the present invention as (A) it specifies mounting onto the windshield, and (B) is identified as a support panel for multiple accessory items that include sun visors.

In U.S. Pat. No. 4,874,938, dated Oct. 17, 1989, Mr. Cliff Chuang, of Lowell, Mass., discloses a “ . . . system including sun direction detectors and an electrically operable sun visor system for use on motor vehicles such as buses, trucks, and automobiles.” He goes on to further disclose that “ . . . it is a further object of the present invention to provide an automatic motor vehicle visor system that avoids some of the limitations of the prior visor systems.” He further discloses “ . . . it is another object of the present invention to provide a visor system that automatically positions the visor to the appropriate lateral position depending on the relative azimuth direction of the sun and automatically extends the visor depending upon the relative elevation direction of the sun, even while those relative directions of the sun to the vehicle change.”

Mr. Chuang goes on to further describe “Other sun visor apparatus that has been proposed provides a track for a laterally moveable sun visor along the top of the windshield so that the driver can move the visor manually along the track to a desirable lateral position and then tilt the visor up or down to block the sun. Such a system avoids the limitations of the automatic system described above inasmuch as there is nothing blocking the operator's view and the visor can be moved laterally as necessary to block the sun when the sun is to the left or right of the driver and not just straight ahead. However, such manually operated visors requires the driver to interrupt driving and move the visor along the lateral track and then tilt it as necessary to block the sun. When driving along a road that turns frequently, the driver must make frequent manual adjustments in the lateral position in the visor and the tilt of the visor to keep the sun from his eyes.”

In considering the automatic operation factor of the device of Mr. Chuang, it is sincerely believed by the inventor of the present invention for which protection is being sought herein, that such an automatically activated system, as applied to devices of the present art's environment, i.e., the interior area of an automobile near the driver's head, could prove to be dangerous if activated at a disadvantageous moment, without the driver's knowledge or anticipation, distracting the driver's attention, or possibly even striking the driver about the head or eyes in some particular emergency situation, thus perhaps causing an accident and/or injury to occur.

In the U.S. Pat. No. 6,328,370, and dated Dec. 11, 2001, the system of Mr. Sang R. Kim is disclosed as “ . . . a sun visor rod that extends from a position above and near the center of a windshield, curves around the vehicle and terminates near the end of a vehicle side window.” The rod system of Kim is disclosed as being of two pieces which are mirror images of each other, originating at a vehicle's side window, and terminating and meeting each other at a point above the center of the windshield of said vehicle, having no continuity between the two pieces, especially where they meet at said point above the center of the windshield. The system of Kim is further comprised of an attachment assembly that is slidably attached to said rod assembly, said attachment assembly requiring the intervention of the driver to manually position said attachment assembly to an optimal position, and there manually tighten a locknut assembly for holding said attachment assembly in that location until changing conditions require the further relocating of said attachment means to a new location by releasing said locknut, manually repositioning said attachment means, then manually retightening said locknut. It is further noted that this inconvenient operation is only for the driver's side half of the system. In most instances, it would be unsafe and physically impossible for a driver to attempt to operate the passenger's side attachment assembly in this manner, even though it is well-known that the bright sun light often enters the vehicle from some direction from the passenger's side.

As can be seen from the number of patents hereinabove referenced, many such patents have already been issued for devices pertaining to this art, disclosing a multitude of related methods for attempting to accomplish the common purpose of shielding the eyes of a driver of a motor vehicle from the blinding glare of external bright lights, such as from the sun, for example. Given this plentitude of approaches to the accomplishing of this task, one might be led to conclude that all facets of this art had already been disclosed. However, although some of the prior art referenced herein has disclosed devices and systems similar to those of the present invention for which patent protection is herein being sought, none has fully accomplished said purpose which has been repeatedly stated throughout substantially all of the prior art.

Furthermore, it is noted that all of the prior art that has heretofore resulted in the granting of patents has been submitted and disclosed at least three years prior to the present date, yet none has been selected by any automobile manufacturer for use in any motor vehicles to date. This very lack of utilization could suffice to prove that none of said prior art has been considered by said manufacturers to have adequately accomplished said stated purpose of shielding a driver's eyes from bright lights.

These illustrations of the differences between the Prior Art and the system of the present invention's having been compared, the following description of the system of the present invention is herewith presented.

### SUMMARY OF THE INVENTION

The system of the present invention addresses one long-standing need for a more effective method of shielding an automobile driver's eyes from the glare of a bright sun under certain conditions that vary from time to time and place to place. The current state of this art, as practiced by today's automobile manufacturers, i.e., the continued use of outmoded, non-transparent sun visors, is felt to be inadequate and ineffective. Furthermore, the inventor of the system of the present invention is of the opinion that all of the devices or systems of the hereinabove described Prior Art have likewise failed to fully satisfy the requirements of a system to attenuate the amount of bright light reaching the eyes of a driver of a motor vehicle while still allowing the driver to possess substantially unimpeded vision of the extra-vehicular environment.

Accordingly, the system described herein is presented as a preferred solution to this problem. It is an object of the system of the present invention to substantially reduce the amount of bright light entering a vehicle from an external source, such as the sun, for example, that is allowed to reach the eyes of a driver of said vehicle, said bright light originating from any directional point within an area lying generally along the front or either side of said vehicle, being an area of at least one hundred eighty degrees.

It is a further object of the system of the present invention to provide such a light attenuating means while simultaneously maintaining the driver's vision substantially unimpeded.

It is a further object of the system of the present invention to provide such a light attenuating means in an environment that is controlled by the driver of said vehicle in a manner that is substantially unobtrusive to said driver's operation of said vehicle.

In a preferred embodiment, the system of the present invention comprises a light attenuating means to replace those non-transparent devices commonly known as “sun visors,” together with a support and conveyance means attached to the metal body of the automobile structure and lying throughout substantially all of said area of at least one hundred eighty degrees, for conveying said light attenuating means throughout and along the entire length of said support means, whereby said light attenuating means, being hingedly attached to said carrier means, may be repositioned to any desired horizontal location throughout the length of said support means, with said attenuating means being simultaneously pivotally movable from a fully horizontal position while stowed, to a generally more vertical orientation, thus accomplishing said stated and desired purpose of attenuating the amount of said bright light being allowed to reach the eyes of a driver of an automobile.

### BRIEF DESCRIPTION OF THE SEVERAL VIEWS OF THE DRAWINGS

The above-mentioned features of the present invention will become more easily understood from the following detailed description of the present invention when read together with the drawings in which:

FIG. 1 represents an exemplary rendering of a support and conveyance means 101, together with a repositionable carriage 104 and a light attenuating means 102 hingedly attached thereto, said light attenuating means 102 being a semi-transparent plate shown as partially deployed from holder 100 by means of tab 103.

FIG. 2 discloses an exemplary cable driving motor 107, a supply and take-up reel 108 and an idler take-up reel 109 for use in repositioning a repositionable carriage 104 along said conveyance and support means 101.

FIG. 3 is an exemplary rendering of one embodiment of the tracking path of said driving cable 106 in a plan view.

FIG. 4 is a depiction of one possible construction of said repositionable carriage means 104 illustrated within said support and conveyance means 101, for bearing with it said light attenuating means 102 hingedly attached thereto.

FIG. 5 illustrates a detailed view of said repositionable carriage means 104 and said hingedly attached light attenuating means 102 disclosing one possible embodiment of a hinge 110.

FIG. 6 is a detailed cutaway depiction of said repositionable carriage means 104 together with said connecting hinge 110 for attaching said attenuator holder 100, disclosing an attaching bolt 116.

FIG. 7 is a wiring diagram of one possible configuration for controlling an electrically powered carriage means in which is disclosed a driving motor 107, a spring-loaded, triple pole, double throw, center off position direction switch 115, a system master power on switch 114, the automobile ignition switch 113, and the automobile battery shown with the negative pole connected to the vehicle ground 117.

### DESCRIPTION OF THE PREFERRED EMBODIMENTS

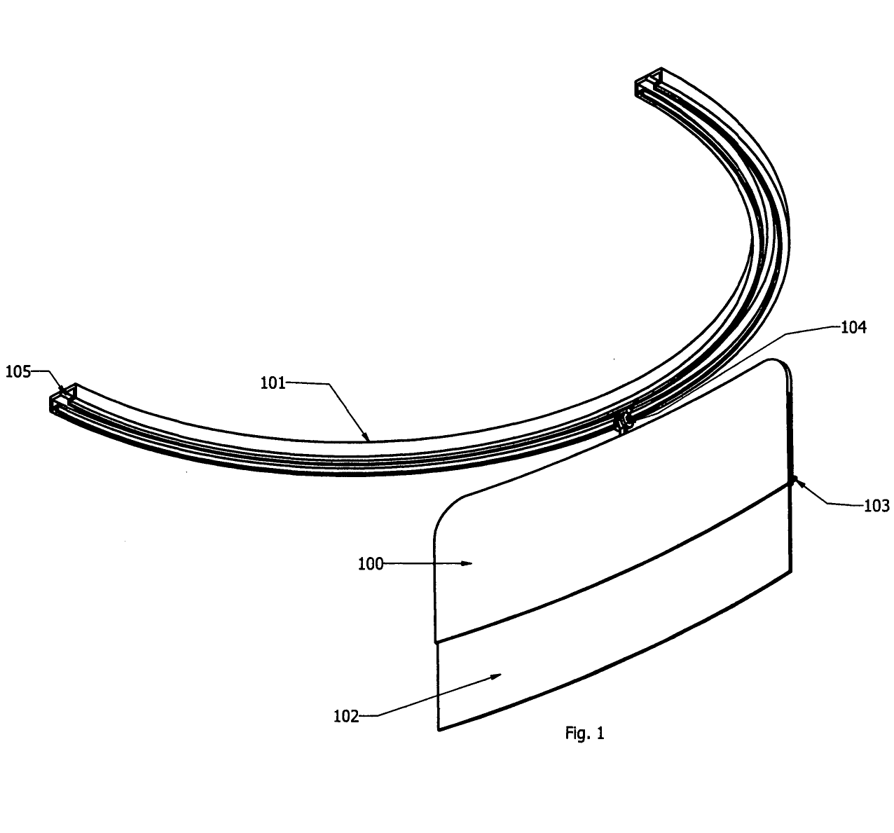

Referring now to the drawings, and more particularly to FIG. 1, a system for attenuating the amount of bright light from an external source, such as the light from the sun, for example, reaching the eyes of a driver of an automobile, is disclosed, such a system being a cohesive arrangement of several components cooperatively functioning together, said system including a supporting and conveyance means 101, which, in the exemplary embodiment, is defined as a curvilinear track 101, configured so as to enclose a spatial area within the front portion of an automobile of at least one hundred eighty (180) degrees within the shape of said curvilinear track 101, said curvilinear track 101 containing at least one continuous open groove 105 throughout its length, having a repositionable carriage means 104 appropriately mounted therein, and which, with a light attenuation means 102 attached thereto, may be conveyed through a fixed path directionally defined by said shape of said grooved curvilinear track, conveying said light attenuation means 102 to any desired location along said fixed path around an area of at least one hundred eighty (180) degrees. The light attenuation means 102 is further disclosed as a curved plate of semi transparent and darkened material, such as glass or plastic, for example. Further, said light attenuation means 102 is wholly contained within holder 100, an opaque container composed of a rigid material so shaped as to correspond to the exact shape and size of said light attenuation means 102 and to serve as a receptacle for said light attenuation means 102 while in the non-deployed position, said light attenuation means 102 being deployable in a vertical direction by means of a tab 103 permanently attached thereto.

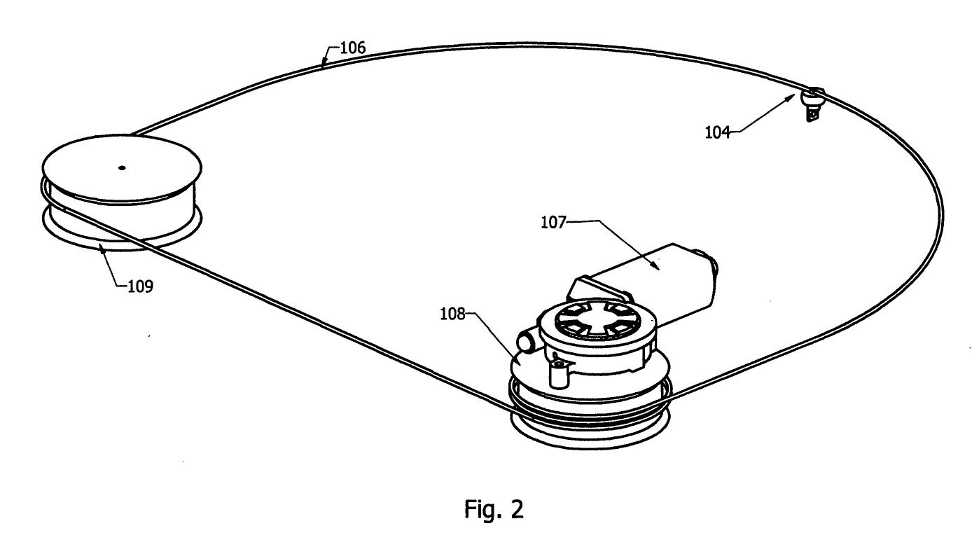

The drawing of FIG. 2 illustrates the detail of one embodiment of a means for repositioning an electrically powered carriage means 104 along said predetermined path, said repositioning means being composed of a cable 106, a supply and take-up reel 108, driven by electric motor 107, and an idler take-up reel 109.

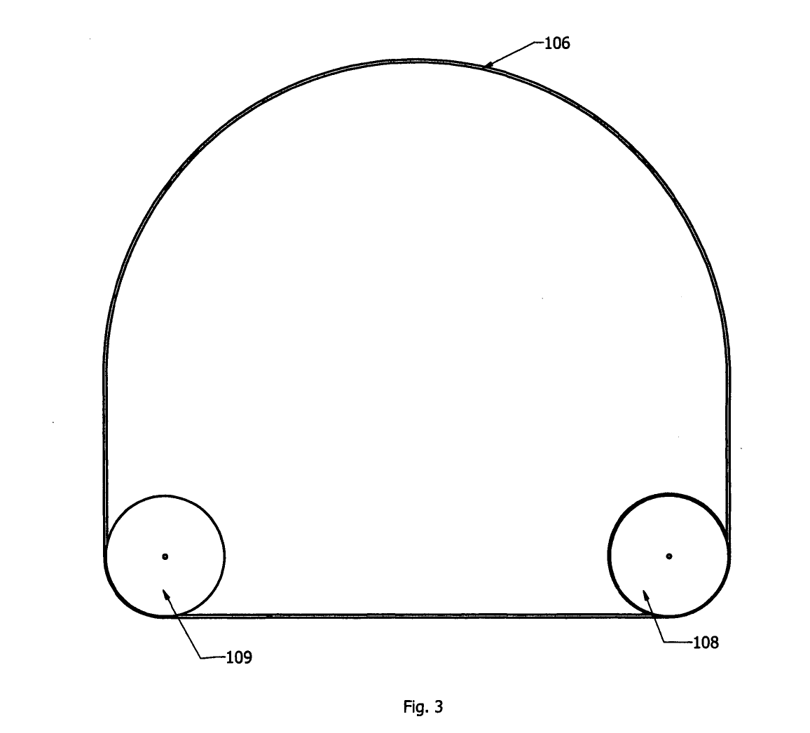

FIG. 3 illustrates a plan view of the tracking path of said driving cable 106, including supply and take-up reel 108 and idler take-up reel 109.

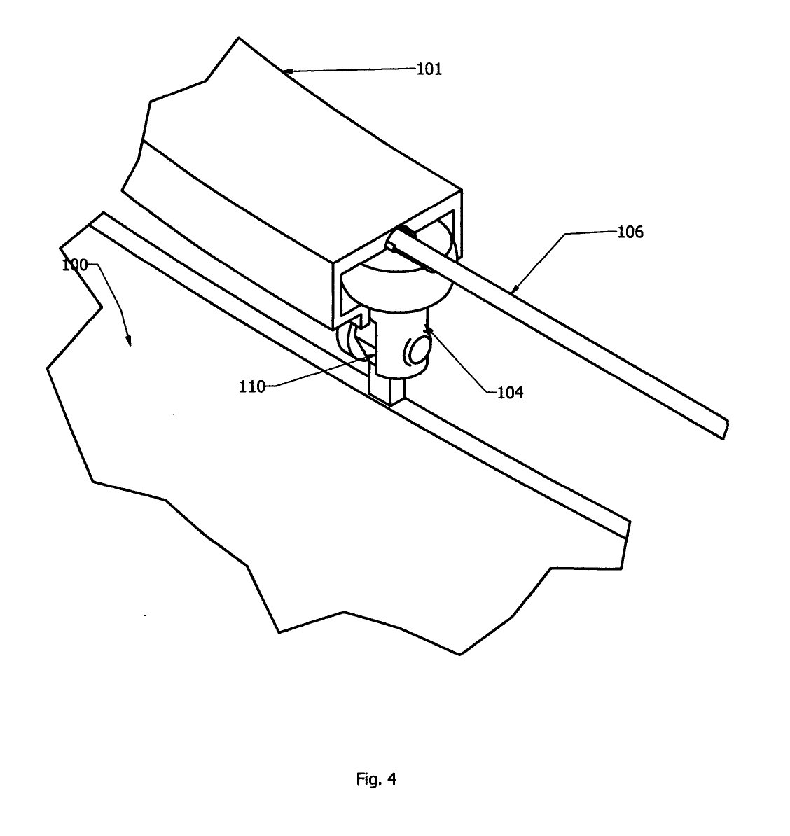

The drawing of FIG. 4 illustrates the detail of one possible construction of said repositionable carriage means 104, interfaced with said grooved curvilinear track 101, and supporting said light attenuator holder 100, together with said driving cable 106, and disclosing an exemplary hinge 110.

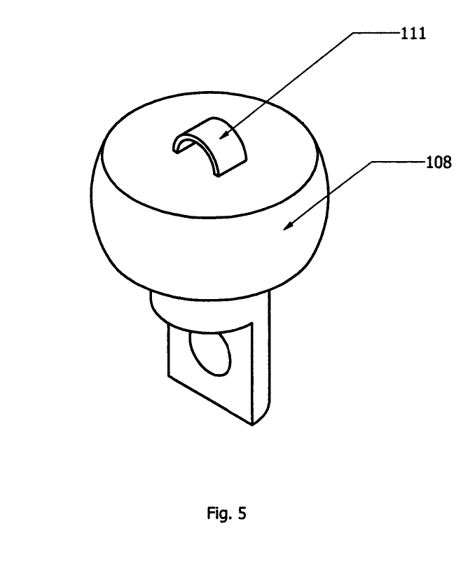

FIG. 5 illustrates a detailed cutaway view of said light attenuating means holder 100 hingedly attached to said repositionable carriage means 104, disclosing an exemplary hinge 110, attaching bolt 116, and attaching eyelet 111.

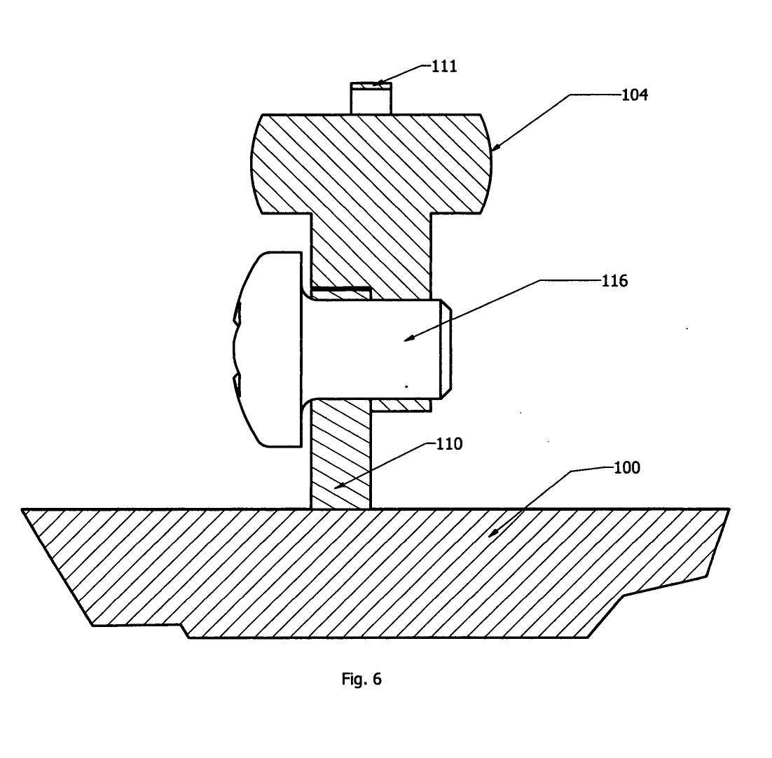

FIG. 6 is a detailed view of said repositionable carriage means 104 disclosing an eyelet 111 as one possible method of attaching said cable 106 thereto.

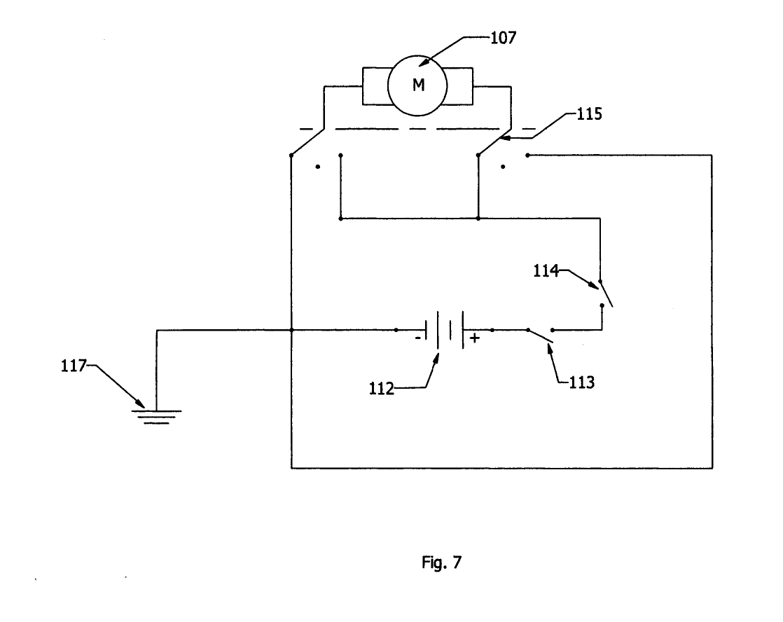

FIG. 7 is a schematic diagram of one possible method of electrically powering the system of the present invention. Supply voltage from the vehicle battery 112 is made available through vehicle ignition switch 113 and light attenuating system master power on switch 114 when these switches, illustrated now in the open, or non-operating position, are in the closed, or operational, position. Motor 107 is caused to rotate in one direction or the other by Direction switch 115, a spring-loaded, double pole, triple throw switch with a center off position.

### DETAILED DESCRIPTION OF THE INVENTION

In a preferred embodiment, the system of the present invention comprises a light attenuating means 102 for reducing the amount of light allowed to reach the eyes of a driver of an automobile while still providing substantially unimpeded vision in an outward direction through said light attenuating means 102, a repositionable carriage means 104 for conveying said light attenuating means 102 hingedly attached thereto, a support and conveyance means 101 for supporting said repositionable carriage means 104 and said light attenuating means 102, and a control means 115, all of which, when appropriately combined and functioning together, accomplish the purpose of the system of the present invention, which is that of providing a means of reducing (attenuating) the amount of light from a bright light source that is allowed to reach the eyes of a driver of an automobile, without substantially impeding said driver's normal field of vision. Said bright light entering the automobile from an external source, such as the sun, for example, is attenuated by the system of the present invention through the use of a unique and original light attenuating means 102, together with a repositionable carriage 104, which is also unique and original, for repositioning said state-of-the-art light attenuating means 102 to any position wherever desired along a curvilinearly-shaped support and conveyance means 101, enclosing a spatial area of at least one hundred and eighty (180) degrees throughout both the forward and lateral portions of the interior of said automobile, said curvilinearly-shaped area being that area defined by the field of vision of a driver of an automobile, as said driver is able to look from his or her extreme left side to his or her extreme right side, said repositionable carriage 104 thus causing said light attenuating means 102 to be juxtaposed between the eyes of the driver of the automobile and said external bright light source, thereby attenuating the amount of said bright light that is allowed to reach the eyes of an automobile from all possible exposure angles, thus effectively rendering obsolete all such similar, previously employed, non-transparent devices generally known as “sun visors,” together with prior art attempts to accomplish said purpose of this invention.

In an exemplary embodiment, said light attenuating means 102 is formed of a glass or plastic light-attenuating material that may be permanently darkened prior to its installation. In another embodiment, said glass or plastic light attenuating material 102 may be of a special material known to those trained in the art of optics and optical devices, that significantly reduces the amount of light allowed to pass through said device in an inward direction, for example, while simultaneously allowing substantially unobstructed viewing in the opposite, or outward-looking, direction, by automatically darkening itself upon being impinged upon by the rays of said light source, especially the Beta rays of the sun, for example. The size, shape, coloration, and material of said light attenuating means 102 may vary significantly, depending upon the circumstances of individual environments, but in a preferred embodiment, is comprised of at least one generally rectangularly-shaped but curved in the horizontal plane plate of light attenuating material, which may be hereinafter referred to as the “attenuator 102.” The scope and purpose of this invention is to provide a new and, finally, effective, means for adequately shielding automobile drivers from the dangerous conditions caused by said driver's being blinded by a bright light, such as the sun, for example. The size and shape of said attenuator 102 should be of sufficient proportions as to accomplish the purposes of this invention, said proportions including being generally rectangular in shape, having a longer horizontal plane comprising a top and a bottom edge of approximately 24 inches in length, and a left and a right edge of approximately nine inches in a vertical plane, with a generally inward curvature of the horizontal plane throughout its entire length so as to follow the general shape of windshields and vehicle interiors, and to avoid striking the automobile's roof supports or other structures, or a driver or a passenger while in said automobile during the function of being repositioned from one location to another.

Said attenuator 102, being hingedly attached to said carrier means 104, may be maneuvered into a desired location along said defined path by said driver means 107, either by powered means, such as an electric motor, for example, or manually, if desired. In a preferred embodiment, the act of manually rotating said attenuators 102 from a horizontal stowed position into a generally more vertical orientation serves to operate a Master Power switch 114, located on the repositionable carriage 104 to support said attenuator 102, from a normally open, or Off, position, to an On condition, thereby making available the electrical voltage for powering said powered driving means 107. A Direction switch 115 or other means for further controlling said powered means 107 can be located in a convenient position for said driver's use, such as on an automobile steering wheel, for example.

In one exemplary embodiment, said automobile driver may activate the system of the present invention by manually rotating holder 100 from a horizontal stowed orientation to a generally vertical deployed orientation, which action places System Master Power Switch in an On mode, allowing electrical voltage to be present at the terminals of Direction switch 115. Thereafter, said repositionable carriage means 104 may be moved into any desired location along said linear path defined by said support means 101 by the moving of Direction switch 115 into an On position, causing said electrical voltage to be applied to reversible-direction motor 107 which is thereby caused to rotate in a first or a second, opposite direction, dependent upon the position of Direction switch 115. The rotation of motor 107 rotates circular reel 108, mounted on said electrical motor 107, in a said first or second, opposite, direction, thereby pulling a steel cable firmly attached to said repositionable carriage 104, causing said carriage 104 to move along groove 105 of support means 101 in a said first or second direction until said automobile driver moves Direction switch 115 to an open, or Off, position, carriage 104 having reached the desirable location. A receiving circular take-up reel 109 maintains the necessary tension on cable 106 by receiving a surplus of said driving cable 106 and allowing said cable 106 to be retrieved by take-up reel 108.

Other art discloses multiple other means, such as hydraulic or vacuum means, etc., of activating said repositionable carriage 104 which are therefore not addressed in detail in this application.

In a preferred embodiment, said support means 101 is so configured as to provide for the positioning of said attenuating means 103 throughout the full frontal and lateral areas of an automobile, beginning at a position at the rear of the left side of the automobile's front left door and traversing from that position to any selectable location to the limit of a position just behind the rear of the right side front door, thus encompassing a curvilinearly-shaped area of at least one hundred and eighty (180) degrees, while possessing the ability to be halted at any desired position intermediate to and including these two extreme locations.

The preferred embodiment of the present invention is that said supporting means is a generally rectangularly-shaped tube of a rigid material, such as an aluminum alloy, for example. It is envisioned as being formable into any necessary desired shape for sale on the automotive after-market for being retrofitted into existing automobiles, and of also being custom-built into any vehicle and installed at a manufacturer's factory.

In either case, in a desired and practicable embodiment, said supporting means would be attached to the interior of the structure of an automobile above the top of the windshield, and extending to both the left and right sides to terminating extremes at the rear edges of the corresponding left and right-side doors of said automobile, encompassing at least a full one hundred and eighty (180) degrees, so as to juxtapose said attenuator 102 between said bright light and said driver's eyes, thus creating a Circle of Shade for said driver's eyes.

While this invention has been described as having a preferred design, it will be apparent to those skilled in the art that the present invention can be further modified within the spirit and scope of this disclosure without detracting therefrom. This application is therefore intended to cover any variations, uses, or adaptations of the invention using its general principles. Further, this application is intended to cover such modifications of the present disclosure as come within known or customary practice in the art to which this invention pertains and which fall within the limits of the attached claims. Therefore,

What is claimed as the invention of this application is:

1. An apparatus for reducing the amount of light from external sources that may enter an automobile from virtually any angle through the forward windshield and/or the front lateral windows, that is allowed to reach the eyes of a driver of said automobile, comprising:
A light attenuating means, hingedly attached to a repositionable carriage means, and a rigid but customizably-shaped support means attached to the structure of the interior of an automobile, whereby said repositionable carriage means, couplably configured with said support means so as to move freely along said support means, is operable to convey said light attenuating means to any selectable location throughout and along the total fixed path described by said customizable shape of said support means.

2. The apparatus of claim 1 wherein said light attenuating means is an opaque holding unit, shaped in a curvilinear manner so as to pass smoothly by the roof support structure of said automobile as said carriage is being repositioned from one location to another along said carrier means, said opaque holding unit containing a slidably extractable semi-transparent light attenuating plate.

3. The apparatus of claim 1 wherein said light attenuating means is made to be safe to the driver in the event of a crash by being coated with, or containing within two layers, an adhesive material such as that used in Safety Glass, for example, so as to prevent shattering, in case of an accident.

4. The apparatus of claim 1 wherein said light attenuating means is made of a material that automatically darkens temporarily when struck by incident light, particularly the Beta rays of the sun and/or the headlights of oncoming automobiles.

5. The apparatus of claim 1 wherein said light attenuating means is composed of a selected material, such as glass or plastic, for example, that has been selectively darkened prior to installation, in which said darkening graduatedly varies from the darkest shade at the top of said attenuator, and decreases in gradations of shade to a least darkened coloration at the bottom.

6. The apparatus of claim 1 wherein said repositionable carriage means is caused to be repositioned from one position to another along said support means by means of a driving cable with interoperably configured cable reels and driving motor, together with appropriate controls.

7. The apparatus of claim 1 wherein said repositionable carriage means is caused to be repositioned from one position to another by electric, pneumatic, vacuum, hydraulic, or other powered means.

8. The apparatus of claim 1 wherein said repositionable carriage means is caused to receive activation signals either wirelessly, as by radio wave transmission, or by direct connections through an interface arrangement.

9. The apparatus of claim 1 wherein said support means is composed of a variable number of customizably shaped sections couplably interlocked with one another so as to provide a support and conveyance means that conforms to the unique shape of the interior of a particular automobile.

10. The apparatus of claim 1 wherein said light attenuating means causes the system to be activated when rotated from a horizontal stowed orientation to a more generally vertical orientation.
